(19) United States
(12) Patent Application Publication
(10) Pub. No.: US 2023/0309541 A1
(43) Pub. Date: Oct. 5, 2023

(54) NOZZLE SPECIFIC SPRAY APPLICATION MONITORING

(71) Applicant: BASF AGRO TRADEMARKS GMBH, Ludwigshafen (DE)

(72) Inventor: Steffen TELGMANN, Köln (DE)

(21) Appl. No.: 18/019,529

(22) PCT Filed: Aug. 27, 2021
(86) PCT No.: PCT/EP2021/073774

§ 371 Date: Feb. 3, 2023

(30) Foreign Application Priority Data
Aug. 31, 2020 (EP) 20193658.0
Oct. 23, 2020 (EP) 20203513.0

(51) Int. Cl. A01M 7/00

(52) U.S. Cl. CPC A01M 7/0089

(57) ABSTRACT

A spray device (20) with more than one spray nozzle (28) to treat an agricultural area (11), wherein at least two spray nozzles (28) are fluidly connected via a common fluidic line (26), the spray device (20) including: - a control system (32) configured to control activation of individual spray nozzle(s) based on an activation signal, - a sensor (34) configured to measure a fluid property in the common fluidic line (26), - a monitoring unit configured to monitor spray nozzles (28) based on the measured fluid property and the activation signal.

The invention relates to a spray device with more than one spray nozzle to treat an agricultural area, a farming machinery comprising the spray device and a method for monitoring spray application of a spray device with more than one spray nozzle as well as respective computer program products and machine-readable storage devices.

### BACKGROUND

In recent years the trend has emerged for farming machinery such as sprayers, harvesters or seeders to allow for more targeted operations on farming fields. Thus far, in particular, with respect sprayers broadcast application has been the norm. Such non-targeted techniques are however inefficient. To increase efficiency by reducing the amount of pesticides applied to the field smart spraying technologies are evolving. These allow to detect conditions in the field and based on such detection control spot spraying operations. For instance, in weed control through a chemical weed control agent, the sprayer is equipped with a camera system that takes images while the sprayer traverses through the field. Real-time image analysis allows for weed detection and targeted spray operations.

For such targeted applications sprayers with multiple nozzles that can be controlled individually are used. Examples of such sprayer arrangements are for instance described in DE102018203791, DE102017220034, DE102018203789. In such systems the targeted application needs to be controlled for each nozzle. Any nozzle failure may lead to reduced applications rates and in the worst case may result in resistances. Hence there is a need to monitor the application rate per nozzle.

WO2014195305A1 relates to an arrangement for measuring a delivery volume and/or a delivery rate. The arrangement comprises a sensor with which values can be measured indicating whether the valve head is in the first or the second position; and an arithmetic unit which is coupled to the sensor and with which the delivery volume of the pump and/or the delivery rate of the pump can be calculated based on the values measured by the sensor.

WO2019091715A1 relates to a method for the acquisition of at least one spray liquid data set of a spay liquid discharged on an agricultural surface by means of at least one spray nozzle unit of a spraying device, having the steps of: - receiving at least one property signal having spray liquid property information acquired by means of a sensor unit of the spraying device in a throughflow region of the at least one spray nozzle unit during the discharge of the spray liquid, - receiving at least one position signal having a spray liquid position information by means of a positioning unit, the position information representing a geographical position of the spray liquid during discharge of the spray liquid; and - saving, together with the associated position information, the property information and/or a spray liquid information of the discharged spray liquid acquired using the property information by means of an information device in order to acquire the spray liquid data set.

It is an objective of the present invention to provide a robust and simple method for monitoring spray application.

### SPECIFICATION

In one aspect the disclosure relates to a spray device with more than one spray nozzle to treat an agricultural area, wherein at least two spray nozzles, preferably multiple spray nozzles arranged next to each other further preferred vertical to a movement direction of the spray device, are fluidly connected via a common fluidic line, the spray device including:
a control system configured to control activation of individual spray nozzle(s) based on an activation signal, preferably derived from detecting conditions to be sprayed on the agricultural area or field,
a sensor configured to measure a fluid property or a property of a fluid, preferably a fluid flow or flow of a fluid, in the common fluidic line,
a monitoring unit configured to monitor the at least two spray nozzles, preferably individual spray nozzles, based on the measured fluid property and the activation signal.

In a further aspect the disclosure relates to a method for monitoring spray application, preferably spot application, of a spray device with more than one spray nozzle to treat an agricultural area, wherein at least two spray nozzles, preferably multiple spray nozzles arranged next to each other further preferred vertical to a movement direction of the spray device, are fluidly connected via a common fluidic line, comprising the steps of:
providing an activation signal for individual spray nozzle(s) to control activation of individual spray nozzle(s) based on an activation signal, preferably derived from detecting conditions to be sprayed on the agricultural area or field,
providing a fluid property measurement via or from a sensor configured to measure a fluid property or a property of a fluid, preferably a fluid flow or flow of a fluid, in the common fluidic line,
monitoring the at least two spray nozzles, preferably individual spray nozzles, based on the measured fluid property and the activation signal.

In yet a further aspect the disclosure relates to a computer program or computer program product, which when executed on a computing device preferably of the spray device lined out above, performs the method disclosed herein.

In yet a further aspect the disclosure relates to a machine-readable storage device or a control device with executable instructions, which when executed on a computing device preferably of the spray device lined out above, performs the method disclosed herein.

In yet a further aspect the disclosure relates to a farming machinery including the spray device, the computer program or the machine-readable storage device or control device disclosed herein.

By measuring the fluid property in the common fluidic line common across more than one nozzle, the solution allows for highly effective monitoring of the spray application even on a per nozzle basis, since not every nozzle needs to be equipped with a sensor. In particular for spray devices with a large boom width and more than five or ten or multiple spray nozzles the savings potential is high, even if small fluid flows in the milliliter per second range need to be detected reliably. Additionally the monitoring based on the measured fluid property and the activation signal allows for a simple way to monitor the treatment task executed by the spray device during treatment operation or after treatment operation. This is particularly advantageous for spot spraying, where locations of the field not treated with the required application rate or composition are harder to detect than for flat spraying applications, where all nozzles are activated at the same time.

The following description relates to all of the above aspects. Any feature may, hence, relate to the spray device, the farming machinery, the methods for monitoring spray application as well as the computer program, computer program product or the machine-readable storage device.

In the context of the disclosure a “common fluidic line” relates to a fluidic line or a line carrying a fluid, which is in fluid communication with a subset of spray nozzles or all spray nozzles. A subset of spray nozzles may include more than two spray nozzles. The disclosure may be applicable to all fluidic setups, which have at least one common fluidic line serving a subset of spray nozzles or all spray nozzles with one or more fluids. Depending on the fluidic set up the common fluidic line may be a line feeding into a distribution line for the subset of spray nozzles or all spray nozzles. The common fluidic line may be a line connecting a subset of spray nozzles or all spray nozzles to one or more tanks. In the case of more than one tank more than on common fluidic line may be present in the spray device. The term “common” is hence to be interpreted as common to the subset or all spray nozzles. The common fluidic line may include a line carrying fluid to the subset or all spray nozzles.

The common fluidic line may carry one fluid from one reservoir such as a tank to the nozzles or a mixture of fluids from more than one reservoir such as a tank to the nozzles. In case of direct injection systems for example, where fluids are mixed directly at the spray nozzle, the common fluidic line may refer to the fluidic line carrying one of the fluids to a subset of spray nozzles or all spray nozzles. In case of a buffer system for example, where fluids are mixed in a buffer volume and then provided to the spray nozzles, the common fluidic line may refer to the fluidic line carrying one of the fluids to the buffer volume or to the fluidic line carrying the mixture from the buffer volume to the subset or all nozzles. In all cases the sensor measuring the fluid property may be placed in any or all of the common fluidic lines serving the subset of spray nozzles or all spray nozzles. Depending on the fluidic setup a back flow, cyclic recovery or cleaning system may be included. In such cases the fluid property, in particular the fluid flow, measured by the sensor in the common fluidic line may be corrected by measuring respective fluid property, in particular the fluid flow, in one or more the back flow, cyclic recovery or cleaning line(s) with respective sensors placed in such line(s).

In one embodiment the spray device includes multiple spray nozzles to allow for targeted treatment. In such embodiment the spray device may include one or more nozzle(s) to release chemical agent to the agricultural area, such as a field for cultivating crop, a green house or the like. The chemical agent may include a herbicide, a fungicide, an insecticide, a nutrient, a fertilizer a plant growth regulator. In a further embodiment the chemical agent may comprise at least one active ingredient. The chemical agent may further comprise a formulation including one or more ingredients. For example the active ingredients may be mixed with water or additive(s) such as oil.

The spray device may comprise one or more tanks holding different ingredients of the chemical agent to be applied. The tanks may include valves, which allow tailored mixing of the ingredients making up the chemical agent to be applied. In such embodiment the spray device may include multiple tanks and based on a sensed condition of the agricultural area the ingredients of specific tanks may be released from the tanks and mixed. Hence the chemical composition of the chemical agent may be chosen based on the sensed field condition. In particular, an activation signal for the tank valves may be determined based on the sensed field condition.

In a further embodiment the spray device is configured to discharge the chemical agent such as a herbicide, a fungicide or an insecticide. Alternatively or additionally, the spray device may be configured to discharge nutrient, fertilizer or plant growth regulator. The spray device may hence be configured to treat crops, weeds, diseases, insects or a combination thereof.

In one embodiment the spray device may be part of a farming machinery. The farming machinery may include further treatment mechanisms to treat the agricultural area. Such treatment mechanisms may include mechanical treatment mechanisms, electrical treatment mechanisms or a combination thereof. The farming machinery may hence comprise further treatment elements in addition to the spray nozzles for chemical treatment, such as grabber arms, rakes, tappets, water jet nozzles or electrical dischargers.

The farming machinery may include a vehicle. The treatment mechanism(s) may be part of the vehicle moving across the field, such as a tractor, an unmanned arial vehicle (UAV) or a robot. Alternatively, the treatment mechanism(s) may be arranged separately and/or releasably attached to the vehicle moving across the field. The vehicle may be an autonomous vehicle, such as an autonomous robot or a UAV moving through the field.

The spray device may further include a detection system. The detection system may be configured to sense or detect field conditions of the agricultural area as the farming machinery or spray device moves through the field. The detection system may comprise one or more detection component(s) to sense or detect field conditions of the agricultural area as the farming machinery or spray device traverses through the field. The detection component may be an optical detection component such as a camera taking images of the agricultural area. The control system may be configured to control the spray nozzles based on the sensed or detected field conditions of the agricultural area.

In a further embodiment the farming machinery or spray device includes one or more treatment element(s) associated with one or more detection component(s). In such embodiment the detection components may be arranged in front of the treatment element(s) when seen in movement or drive direction of the farming machinery. This way the detection component can sense the field condition of the agricultural area, the control system can analyze the sensed field condition and the treatment element, in particular the spray nozzles, can be controlled based on such analysis. This arrangement allows for targeted treatment based on the real-time condition or the agricultural area as present at the time of treatment while the farming machinery traverses in the agricultural area.

In a further embodiment the farming machinery or spray device includes the spray device with multiple spray nozzles associated with multiple optical detection components. In such embodiment the optical detection components may be arranged in front of the spray nozzles when seen in movement or drive direction. Furthermore, each of the optical detection components may be associated with one spray nozzle or a subset of spray nozzles, such that the field of view of the optical component and the spray profile of the associated spray nozzle(s) at least partly overlap as the farming machinery or the spray device moves through the field.

In a further embodiment the control system is configured to analyze the sensed or detected field condition as provided by the detection system. Based on such analysis the control system may be further configured to generate activation signal(s) to actuate the treatment mechanism, such as the spray nozzles. The control system may further be configured to trigger the activation through the activation signal once the position of the treatment mechanism, such as the spray nozzle(s) reached the field position that was analyzed.

In a further embodiment the spray nozzles are in fluid communication with one reservoir, such as a tank, via one common fluidic line or the spray nozzles are in fluid communication with more than one reservoir, such as tanks. In the latter embodiment each reservoir may be connected to the spray nozzles via one or more common fluidic line(s). The fluidic set up of the spray device may be a one-tank setup, where the ingredients of the composition to be sprayed or applied is filled into the tank prior to operation on the agricultural area. A valve may control release into the fluidic line(s) connecting the tank to the spray nozzles. Alternatively, the fluidic set up of the spray device may be a multi-tank setup, where ingredients of the composition(s) to be sprayed are filled into separate tanks. As an example, the active ingredient(s) may be filled into a first tank and water may be filled into a second tank. Additionally, additive(s) such as oil may be filled into one of the first or second tank or into a third tank. Valves for each tank may control release into the fluidic lines connecting the tanks to the spray nozzles. In another example, more than one active ingredient may be filled into separate tanks. Overall, such multi-tank set ups allow for further tailoring of the spray application during operation.

In a further embodiment the activation signal comprises a nozzle identity and a nozzle application mode for each of the at least two or multiple nozzles. The nozzle application mode may relate to a nozzle status such as on or off, a nozzle application rate, in particular an amount to be released by the nozzle per time interval or opening operation, and/or a nozzle composition, in particular a composition of chemical agent to be applied to the agricultural area. In other words, the activation signal may signify based on the detected conditions of the agricultural area, which nozzle is to be controlled how and/or how much chemical agent is to be released. In particular, the activation signal for the nozzles may be determined based on the detected or sensed field condition. The activation signal may include further valve settings to control the composition of a chemical agent present at the nozzle on activation. Here the valve settings may relate to any valves in the fluidic system, e.g. the tank valves, that impact composition of the chemical agent at the spray nozzle prior to application on the agricultural area.

In a further embodiment the monitoring unit is configured to determine an expected fluid property based on the activation signal and/or historical data. To determine the expected fluid property from the activation signal, the activation signal may be correlated to a pre-defined fluid property. E.g. for spot application a constant fluid amount to be release per nozzle may be used to determine depending on the activation signal, how many nozzles are on and what fluid amount to be applied to the agricultural field this configuration of on-nozzles relates to. Depending on the desired accuracy, the expected fluid property may be determined based on historical data from previous operation runs of the spray device or based on fluid property detected during ongoing operation run on the agricultural area. The historical data may include the measured fluid property and the corresponding activation signal. Such data then allows to determine dependency between the fluid property and the activation signal.

In a further embodiment the monitoring unit is configured to correct a measured fluid property, in particular the fluid amount applied as determined through fluid flow measurement, based on back flow or cyclic flow of fluid to the tank(s) after one or more spot application(s). Additionally, or alternatively lost or not applied fluid detected during cleaning of the fluidic system may be used for correction of the measured fluid property. Additionally, in spray devices with one or more sensor(s) detecting back/cyclic flow such information may be used to update a tank fill level.

In a further embodiment the fluid property relates to a fluid amount to be applied (expected fluid property), the fluid amount applied as determined through fluid flow measurement, a fluid composition to be applied (expected fluid composition) and/or a fluid composition applied as determined through fluid composition measurement. In a further embodiment the monitoring unit is configured to determine a fluid amount applied through a fluid flow measurement and/or a fluid composition applied as determined through a fluid composition measurement. The fluid flow may be measured through a flow sensor configured to detect fluid flows e.g. in the microliter/min to multiple milliliter/min area. Detection limits may lie between 500 ml/min and 100 ml/min, preferably between 500 ml/min and 50 ml/min or further preferred between 1-20 ml/min, e.g. 2 ml/min or 10 ml/min. The flow sensor may be an acoustic, electrical or any other suitable sensor. State of the art CMOS sensors are one option to measure small fluid flows and determine deviation of expected fluid amount or fluid amount applied from such measurement.

The fluid composition may be measured through a fluid composition sensor configured to detect fluid composition e.g. composition of a chemical agent. The composition may be provided by the fraction of active ingredient present in the fluid flowing through the common fluidic line. Further ingredients may be measured. Suitable sensors may be spectroscopic sensors measuring the ingredients e.g. via electrical or optical methods. Such sensors may be placed in the common fluidic line prior to the nozzle, where the composition of the chemical agent as present at the spray nozzle can be measured. If e.g. multiple ingredients like water, active ingredient and other formulation ingredients are mixed from multiple tanks, monitoring of the mixture making up the composition may take place at a position in the fluidic system, where the mixture making up the composition is present. One such sensor may be placed in a common fluidic line or multiple such sensors may be placed in a line relating to one spray nozzle or a subset of spray nozzles. In the latter case a more tailored measurement for one nozzle or the subset of nozzles is possible. By monitoring the fluid composition, the quality of the treatment can be tracked during or after treatment operation not only with regard to the application rate but also with respect to the composition. These two factors

In an additional or alternative embodiment, a flow sensor may be placed in the fluidic line connecting the tank with the ingredient of interest to the common fluidic line. From such flow measurement the fraction of e.g. active ingredient present in the fluid composition may be determined. If more than one ingredient is of interest a flow sensor may be places in each fluidic line connecting respective tank to the common fluidic line. This way the fraction of the ingredients of interest present in the fluid composition may be determined via the measured flow out of the tank. Such values may be corrected depending on the fluidic setup e.g. including dead volumes of back/cyclic flow elements.

In a further embodiment the spray device comprises or is communicatively coupled or connected to a positioning system configured to provide a position information to the monitoring unit or control system corresponding to the time of the measurement of the fluid property. Such positioning system may be part of the spray device or of the farming machinery. It may for instance be part of the control system of the spray device or a monitoring unit.

In a further embodiment the monitoring unit or control system is configured to record the measured and optionally expected fluid property and further optionally the position information during spray operation. This way as applied maps can be recorded by storing the time, fluid property corresponding to such time, the position corresponding to such time and optionally the activation signal information corresponding to such time. As a result, the data collected during operation can be stored and used after operation for further analysis. Here the real or as measured fluid property, such as the fluid amount as applied or the fluid composition as applied, may be recorded optionally together with the activation signal including the information on which nozzle was triggered when with which control signal.

In a further embodiment the monitoring unit or control system is configured to provide a warning signal, if the measured fluid property diverges from the expected fluid property. In case of the measured fluid property being too high, too low or not matching the expected fluid property, the warning signal may be triggered. Such signal can either be sent to a user device, such that the user of the spray device is alarmed. The warning may be visual, acoustic, haptic or any combination thereof. The user device may be located in the farming machinery or on a mobile device of the user. Such warning signal may for instance be triggered, if the deviation between expected fluid property and measured fluid property is larger than a certain percentage, such as 5%, 10%, 15% or 20%.

Furthermore, the monitoring unit or control system may be configured to record the warning signal in association with the measured and optionally expected fluid property and further optionally the position information during spray operation. This way as applied maps can be recorded by storing the time, fluid property corresponding at such time, the position corresponding at such time, the warning occurred at such time and optionally the activation signal information corresponding to such time.

In a further embodiment the monitoring unit is configured to determine at least partially spray nozzle specific fluid property from measurement via a sensor in the common fluidic line, historical data recorded during the operation run or both. Historical data may include data generated by the farming machinery or spray device during operation run on the agricultural area to execute a treatment task. In other words, historical data may refer to data generated by the farming machinery or spray device for already treated locations during the operation run. It may include activation signals and associated fluid property measurements. A preferred fluid property to be determined per spray nozzle is the fluid amount applied from fluid flow measurement via a sensor in the common fluidic line.

In a further embodiment the monitoring unit is configured to determine the spray nozzle position of the problematic spray nozzle, if the measured fluid property diverges from the expected fluid property. Such determination may be derived from historical data recorded during operation run. In other words, historical data may refer to data generated by the farming machinery or spray device for already treated locations during the operation run. E.g. if multiple configurations of spray nozzles have been activated during operation a combinatoric determination of fluid amount applied from flow measurement in the common line may yield the problematic spray nozzle position. This way a single sensor in the common fluidic line can be used to monitor the spray application in a nozzle specific manner. This provides a cheap and effective way to monitor the spray application on a nozzle specific level. Such spray nozzle position may be part of the warning signal. This way the user may be notified that spray nozzle x is defect or is subject to a reduction in fluid applied to the agricultural area. The reduction of fluid applied may for instance be displayed to a user in e.g. percentage reduction.

Furthermore, the monitoring unit may be configured to record the position of the problematic or defect spray nozzle in association with the measured and optionally expected fluid property and further optionally the position information during spray operation. Furthermore, a spray nozzle specific fluid property may be recorded. This way as applied maps can be recorded by storing the time, fluid property corresponding to such time either total value or nozzle specific value(s), the position corresponding to such time, the problematic nozzle position at such time and optionally the activation signal information corresponding to such time. This way any problems that occurred during operation may be tracked after operation and any lack of treatment may be tracked.

In a further embodiment of the method, the method comprises the step of:
providing a condition of an agricultural area and generating an activation signal for individual spray nozzle(s).

Such step may be executed by the detection and control system of the spray device prior to application on the specific agricultural area. Such step may be performed prior to providing the activation signal.

In a further embodiment of the method, the monitoring step comprises:
determining an expected fluid property based on the activation signal and/or historical data, and/or
providing a warning signal, if the measured fluid property diverges from the expected fluid property, and/or
determining a spray nozzle specific fluid property from measurement via or from a sensor in the common fluidic line and historical data recorded during the operation run, such as the current operation run.

In a further embodiment the method comprises:
providing a position information corresponding to the time of the measurement of the fluid property, and/or
recording the fluid property and optionally the position information during spray operation.

### SHORT DESCRIPTION OF FIGURES

Embodiments of the invention are further described in the context of the following figures illustrating:

FIG. 1 an example of a smart farming machinery in a distributed computing environment,

FIG. 2 an example of a spray device,

FIG. 3 a more detailed example of a spray device,

FIGS. 4a-b example setups for placing sensors measuring the fluid property,

FIG. 5 an example of a tank system with multiple tanks,

FIG. 6 an example of a control protocol for sprayer device,

FIG. 7 an example of the method for monitoring the spray application,

FIGS. 8a-b sketch of the principle for monitoring spray application of multiple spray nozzles,

FIG. 9 an example of the method monitoring spray application of multiple spray nozzles,

FIGS. 10a-d example nozzle configurations resulting from different activation signals,

FIG. 11 an example of the method monitoring spray application of multiple spray nozzles.

### DESCRIPTION OF EMBODIMENTS

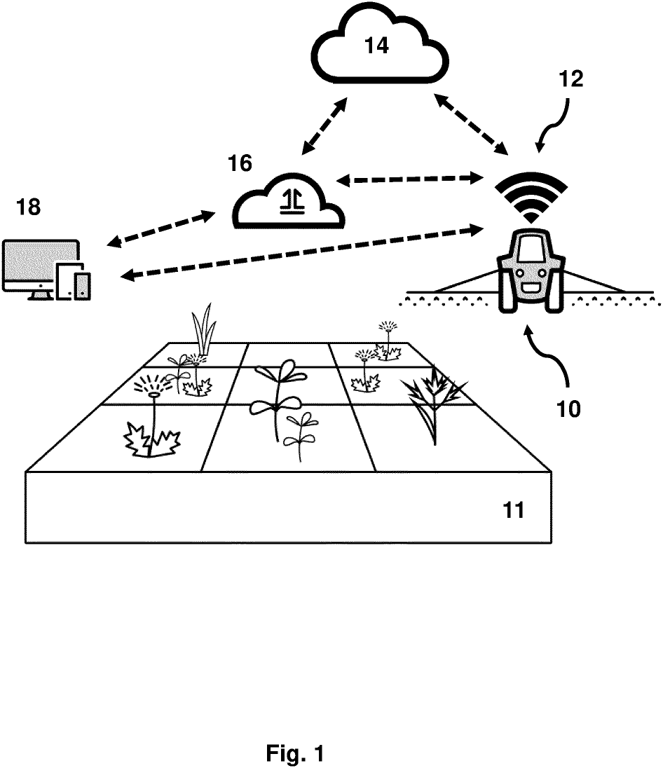

FIG. 1 illustrates smart farming machinery 10 as part of a distributed computing environment. The smart farming machinery 10 may be a smart sprayer or a spray device. The spray device includes a connectivity system 12. The connectivity system 12 is configured to communicatively couple the smart farming machinery 10 to the distributed computing environment. It may be configured to provide data collected on the smart farming machinery 10 to one or more remote computing resources 14, 16, 18 of the distributed computing environment. One computing resource 14, 16, 18 may be a data management system 16 that may be configured to send data to the smart farming machinery 10 or to receive data from the smart farming machinery 10. For instance, as detected maps or as applied maps comprising data recorded during application on the agricultural area 11 may be sent from the smart farming machinery 10 to the data management system 14. A further computing resource 14, 16, 18 may be a field management system 14 that may be configured to provide a control protocol, an activation code or a decision logic to the smart farming machinery 10 or to receive data from the smart farming machinery 10. Such data may also be received through the data management system 16. Yet a further computing resource 14, 16, 18 may be a client computer 18 that may be configured to receive client data from the data management system, the field management system 16 and/or the smart farming machinery 10. Such client data includes for instance application schedule to be conducted on certain fields with the smart farming machinery 10, field analysis data to provide insights into the health state of certain fields or a user interface to display application schedules or field analysis.

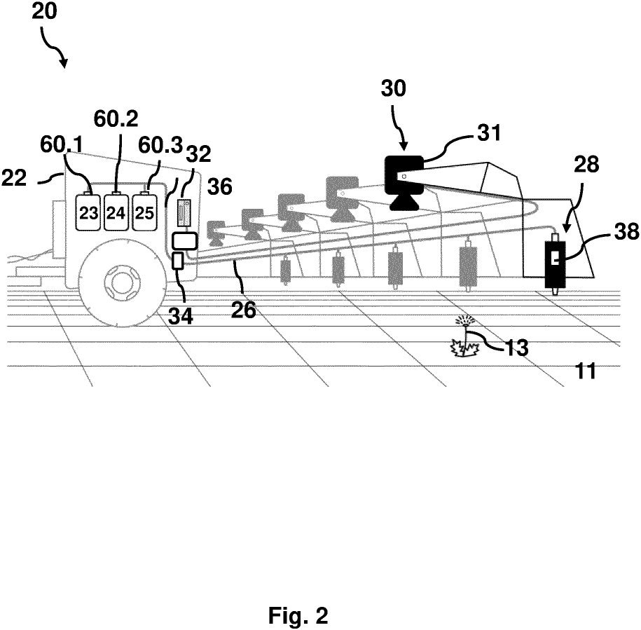

In particular when data is recorded by the farming machinery 10, such data may be distributed to every computing resource 14, 16, 18 of the distributed computing environment. The farming machinery 10 may include a spray device 20 as for instance shown in FIG. 2. The spray device 20 may include a monitoring system 36 for monitoring spray application. In one example the monitoring of the spray nozzles 28 may be done via the least number of sensors 34, 38 built into the fluidic system. Such sensors 34, 38 are preferably placed in the common fluidic line 26 of a subset of nozzles 28 or all nozzles 28. Together with the activation signal for controlling valves, nozzles and/or the tank(s), the system has sufficient information to determine e.g.:
1) deviations of the measured fluid property from the expected fluid property, and/or
2) a spray nozzle specific fluid property, and/or
3) a fluid property as measured by the sensor in the fluidic line, and/or
4) a spray nozzle position causing deviations.

Any such data may be recorded during operation and transferred to e.g. the data management computing resource 16 in real-time during operation run or after operation run of the spary device 10. Based on such data any misapplication on the agricultural area can be analyzed after operation.

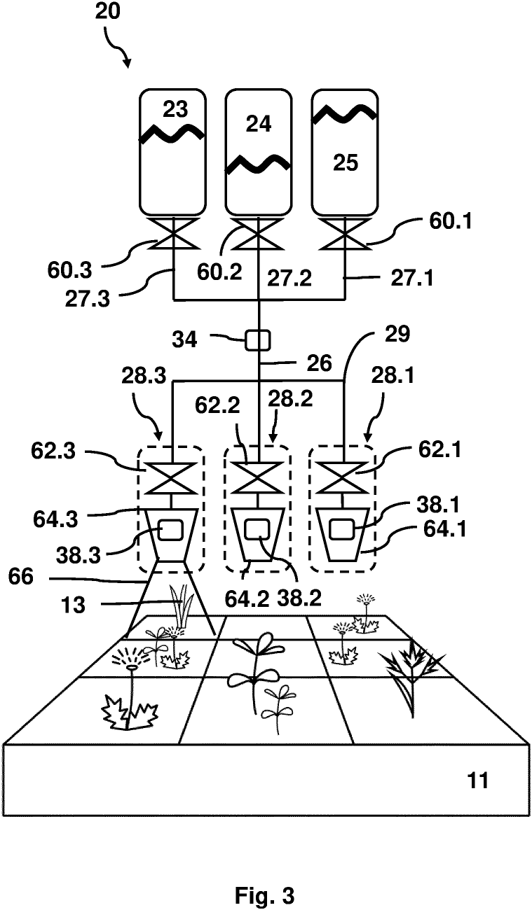

FIG. 2 shows an example of a spray device 20, and FIG. 3 shows a more detailed example of the spray device 20. For the sake of clarity FIGS. 2 and 3 are principle sketches, where the core elements are illustrated. In particular, the fluidic set up shown is a principle sketch and may comprise more components, such as dosing or feed pumps, mixing units, buffer tanks or volumes, distributed line feeds from multiple tanks, back flow, cyclic recovery or cleaning arrangements, different types of valves like check valves, ½ or ⅔ way valves and so on. Also different fluidic set ups and mixing arrangements may be chosen. The invention disclosed here is, however, applicable to all fluidic setups, which have at least one common fluidic line serving a subset of spray nozzles or all spray nozzles with one or more fluids.

The smart farming machinery 10 of FIGS. 2 and 3 comprises a tractor (not shown) with a spray device 20 for applying a pesticide such as a herbicide, a fungicide or an insecticide on the agricultural area 11. The spray device 20 may be releasably attached or directly mounted to the tractor. The spray device 20 comprises a boom with multiple spray nozzles 28 arranged along the boom of the spray device 20. The spray nozzles 28 may be arranged fixed or movable along the boom in regular or irregular intervals. Each spray nozzle 28 may be arranged together with a controllable valve 62 to regulate fluid release from the spray nozzles 28 to the agricultural area 11.

One or more tank(s) 23, 24, 25 are in fluid communication with the nozzles 28, 28.1, 28.2, 28.3 through common fluidic line 26, which distributes the mixture as released from the tanks 23, 24, 25 to the spray nozzles 28, 28.1, 28.2, 28.3. Each tank 23, 24, 25 holds one or more ingredient(s) of the fluid mixture to realsed on the agricultural area 11. This may include chemically active or inactive ingredients like a herbicide mixture, individual ingredients of a herbicide mixture, a selective herbicide for specific weeds, a fungicide, a fungicide mixture, ingredients of a fungicide mixture, ingredients of a plant growth regulator mixture, a plant growth regulator, water, oil, or any other formulation agent. Each tank 23, 24, 26 may further comprise a controllable valve 60.1, 60.2, 60.3 to regulate fluid release from the tank 23, 24, 25 to the fluid lines. Such arrangement allows to control the mixture released to the agricultural area 11 in a targeted manner depending on the conditions sensed on the agricultural area 11.

For sensing the spray device 20 includes a detection system 30 with multiple detection components 31 arranged along the boom. The detection components 31 may be arranged fixed or movable along the boom in regular or irregular intervals. The detection components 31 are configured to sense one or more conditions of the agricultural area. The detection components 31 may include optical detection components 31 providing an image of the field. Suitable optical detection components 31 are multispectral cameras, stereo cameras, IR cameras, CCD cameras, hyperspectral cameras, ultrasonic or LIDAR (light detection and ranging system) cameras. Alternatively, or additionally, the detection components 31 may include further sensors to measure humidity, light, temperature, wind or any other suitable condition on the agricultural area 11.

The detection components 31 are arranged perpendicular to the movement direction of the spray device 20 and in front of the nozzles 28 (seen from drive direction). In the embodiment shown in FIG. 2, the detection components 31 are optical detection components and each detection component 31 is associated with a single nozzle 28 such that the field of view comprises or at least overlaps with the spray profile of the respective nozzle 28 on the field 11 once the nozzle 28 reach the respective position. In other arrangements each detection component 31 may be associated with more than one nozzle 28 or more than one detection component 31 may be associated with each nozzle 28.

The detection components 31, the tank valves 60.1, 60.2, 60.3 and the nozzle valves 28 are communicatively coupled to a control system 32. In the embodiment shown in FIG. 2, the control system 32 is located in the main sprayer housing 22 and wired to the respective components. In another embodiments the detection components 31, the tank valves 60.1, 60.2, 60.3 or the nozzle valves 28 may be wirelessly connected to the control system 32. In yet other embodiments more than one control system 32 may be distributed in the sprayer housing 22 or the tractor and communicatively coupled to detection components 31, the tank valves 60.1, 60.2, 60.3 or the nozzle valves 62.1, 62.2, 62.3.

The control system 32 is configured to control and/or monitor the detection components 31, the tank valves 60.1, 60.2, 60.3 or the nozzle valves 62.1, 62.2, 62.3 following a control protocol. In this respect the control system 32 may comprise multiple modules. One module for instance controls the detection components 31 to collect data such as an image of the agricultural area 11. A further module analyses the collected data such as the image to derive parameters for the tank or nozzle valve control. Yet further module(s) control(s) the tank valves 60.1, 60.2, 60.3 and/or nozzle valves 62.1, 62.2, 62.3 based on such derived parameters.

In addition to the control system 32 the spray device 20 comprises a monitoring unit 36, which may be any processing device with respective interfaces suitable to receive data measured by sensors 34, 38 or from the control system 32. In particular, the monitoring unit is configured to receive data from sensor 34 arranged to measure a fluid property present in common fluidic line 26. As shown in FIG. 3, the common fluidic line 26 serves multiple spray nozzles 28.1, 28.2, 28.3 with a fluid mixture from tanks 23, 24, 25. To control the amount of fluid released from the tanks valves 60.1, 60.2, 60.3 are associated with each tank 23, 24, 25 respectively. Depending on the conditions sensed on the agricultural area 11, the control system 32 determines a composition of the chemical agent to be released and provides the activation signal to the tank valves 60.1, 60.2, 60.3 to provide respective amount to the fluidic lines 27.1, 27.2, 27.3., respectively. In the example of FIG. 3 the fluid streams are mixed in common fluidic line 26 where the mixture is fed into distribution lines 29 to the individual spray nozzles 28.1, 28.2, 28.3. Each spray nozzle 28.1, 28.2, 28.3 includes nozzle valves 62.1, 63.2, 62.3, which is triggered for spraying depending on the activation signal provided by the control system 32. Depending on the desired application rate provided by the activation signal the application nozzles 64.1, 64.2, 64.3 are controlled to spray the respective amount per activated spray nozzle 28.1, 28.2, 28.3 onto the agricultural area 11.

To monitor the operation of individual spray nozzles 28.1, 28.2, 28.3 sensors monitoring fluid properties are used. The fluid property sensed in the common fluidic line may be a fluid flow as measured by sensor 34. Further sensors may measure other fluid properties such as composition of the applied fluid. Such sensors 38.1, 38.2, 38.3 may be placed at each spray nozzle 28.1, 28.2, 28.3 as shown in FIG. 3 or also in the common fluidic line 26 to monitor the composition of the mixture flowing thereto.

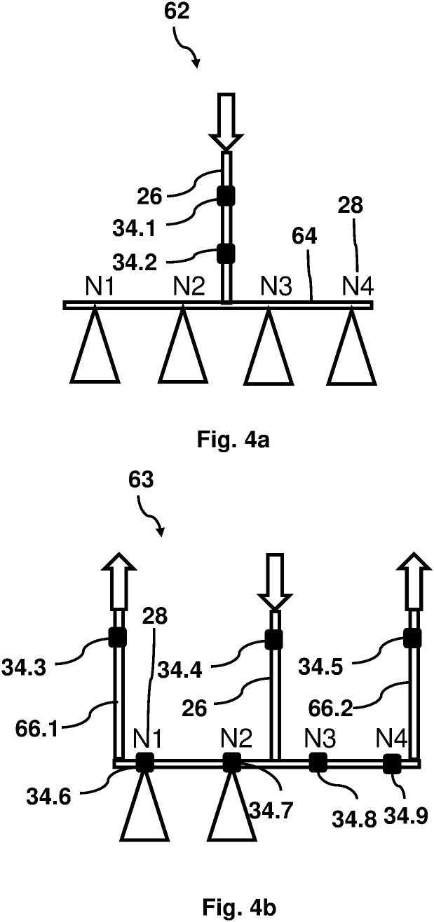

FIGS. 4a and 4b illustrate further example setups for placing sensors measuring the fluid property.

FIG. 4a illustrates schematically a direct injection system 62 with the fluid flow sensor 34.1 and the composition sensor 34.2 placed in the common fluidic line 26. The common fluidic line 26 distributes fluid via the nozzle line 64 to the nozzles 28. In this example four nozzles N1, N2, N3 and N4 are shown for illustrative purposes.

FIG. 4b illustrates schematically a fluidic system with back flow 63. Fluid flow sensors 34.3, 34.4 and 34.5 are placed in the input line 26 and the output lines 66.1, 66.2. Composition sensors 34.6, 34.7, 34.8, 34.9 are placed at each nozzle to measure the composition of the fluid applied through the nozzles 28. In this example four nozzles N1, N2, N3 and N4 are shown for illustrative purposes.

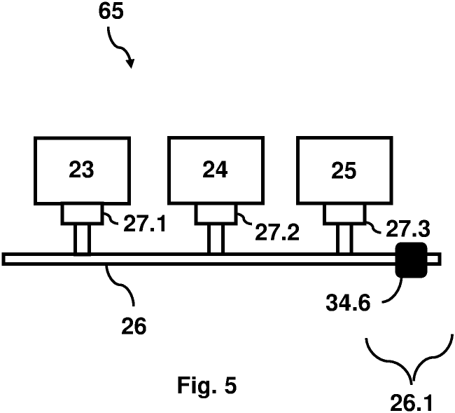

FIG. 5 illustrates schematically a tank system 65 with multiple tanks 23, 24, 25. The multiple tanks 23, 24, 25 are each equipped with one valve 27.1, 27.2, 27.3. The valves 27.1, 27.2, 27.3 control fluid release from the tanks 23, 24, 25. A composition sensor 34.6 is placed in the output line 26 in particular the common fluidic line segment 26.1, where the input line of tanks 23, 24, 25 carry the tank fluids into. The composition sensor 34.6 in such arrangement may measure the composition of the fluid carried by common fluidic line segment 26.1. The fluid carried by the common fluidic line segment 26.1 comprises a mixture of individual fluids released via the valves associated with each tank 23, 24, 25. Depending on the activation signal for the valve control of the tanks 23, 24, 25 the composition of the fluid carried by common fluidic line segment 26.1 may change.

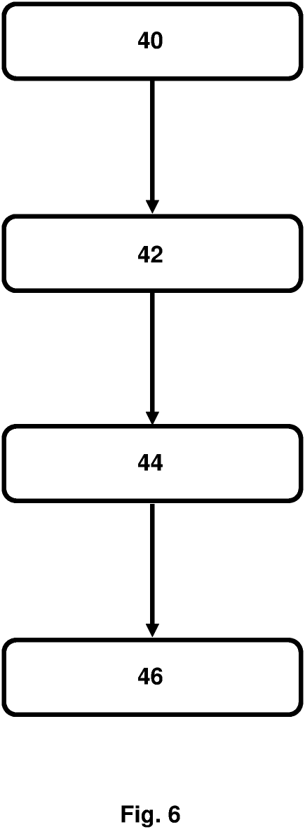

FIG. 6 illustrates an example of a control protocol for the smart sprayer system to control weeds, diseases or insects via a chemical control mechanism.

The control protocol of the spray device 20 may be triggered once the farming machinery 10 activates application operation on the field. In a first step 40 the optical detection components 31 are triggered to provide data such as an image of the agricultural area 11. In a second step 42 the provided data such as the images from the optical detection components 31 are analyzed with respect to weeds, diseases or insects depending on the target of the chemical control mechanism. In a third step 44 parameters are derived from such analysis to derive activation signal(s) for the tanks 23, 24, 25 and the spray nozzles 28.1, 28.2, 28.3. In a fourth step 46 such activation signal(s) are provided to the respective tanks 23, 24, 25 and the spray nozzles 28.1, 28.2, 28.3.

Owing to the system set up each tank valve 60.1, 60.2, 60.3, nozzle valve 62.1, 63.2, 62.3, application nozzle 64.1, 64.2, 64.3 can be controlled individually. Hence if only one image shows the presence of a weed 13, only the respective nozzle 28 associated with that optical detection component 31 having the spray profile covering the field of view of that optical detection component 31 will be triggered. Similarly, if multiple images show the presence of weeds 13 the respective nozzles 28 associated with those optical detection components 31 having the spray profile covering the fields of view of those optical detection components 31 will be triggered.

In addition to such targeted treatment the control of tank valves 60.1, 60.2, 60.3 allows to adjust the treatment composition in dependence on the conditions sensed by the optical detection components 31. For instance, a first tank 23 may include a first herbicide comprising a first active ingredients composition and a second tank 24 may include a second herbicide comprising a second active ingredients composition. Depending on the outcome of the image analysis the valve of the first or the second or both tanks 23, 24 may be triggered to provide respective herbicides for application on the agricultural area.

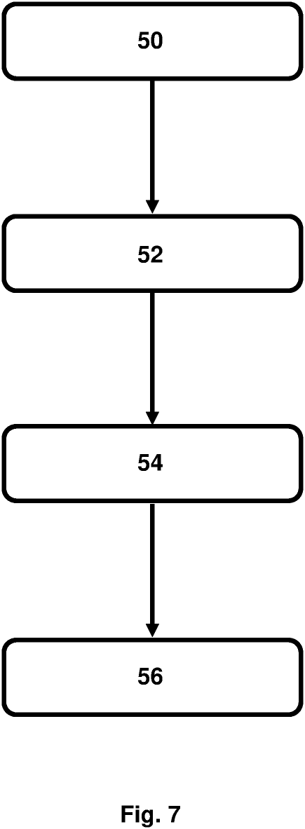

FIG. 7 illustrates an example of the method for monitoring the spray application.

Monitoring of spray application may be embedded into monitoring unit 36 of the spray device 20 or on a different processing device in communication with the farming machinery 10 as shown in FIG. 1. The method for monitoring spray application of a spray device 20 with more than one spray nozzle 28 to treat an agricultural area 11, wherein at least two spray nozzles 28 are connected via a common fluidic line 26, comprises the steps of:
providing, in step 50, a field condition and generating an activation signal for individual spray nozzle(s),
providing, in step 52, an activation signal for individual spray nozzle(s),
providing, in step 54, fluid property measurement via a sensor configured to measure a fluid property in the common fluidic line,
monitoring, in step 56, individual spray nozzles based on the fluid property measurement and the activation signal.

The monitoring step may further comprise the steps of
determining an expected fluid property based on the activation signal and/or historical data, and/or
providing a warning signal, if the measured fluid property diverges from the expected fluid property, and/or
providing a position information corresponding to the time of the measurement of the fluid property, and/or
recording the fluid property and optionally the position information during spray operation.

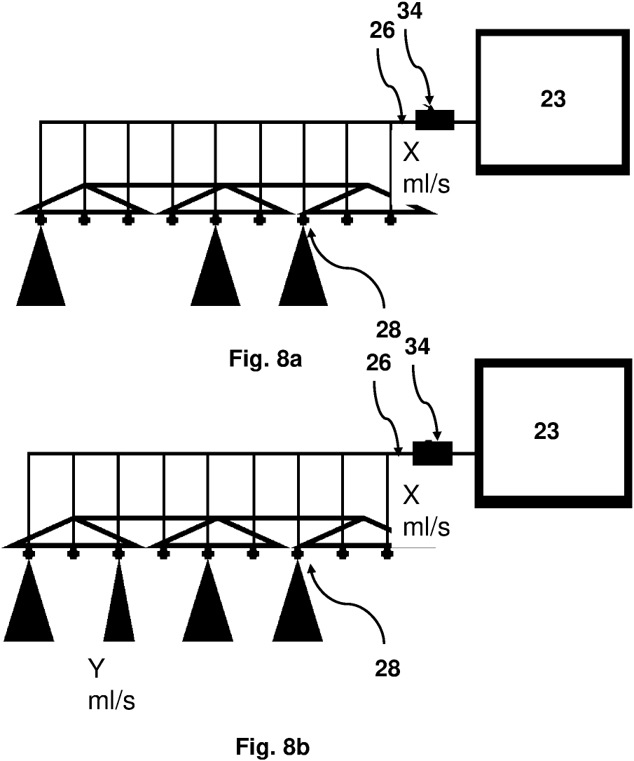

FIG. 8 illustrates an example principle for monitoring spray application of multiple spray nozzles 28.

To monitor in particular the output rate or application rate of individual spray nozzles 28 the sensor 34 is a flow sensor placed in the common fluidic line 26. Based on the activation signal including theinformation, which nozzle is active when, the flow sensor can detect differences of the amount sprayed by active spray nozzles 28. From such measurement the difference or deviation to an expected flow can be calculated. As a result, the current amount sprayed in milliliters per second may be generated. Based on the expected flow per spray nozzle 28 and the derived flow per nozzle 28 from measurement any deviation higher or lower than a threshold such as ± 20% can trigger a warning signal. The warning signal may be displayed to a user. FIG. 6 highlights one situation, where a warning is issued due to one spray nozzle 28 releasing amount Y and not the expected amount of chemical agent per nozzle summing up to X.

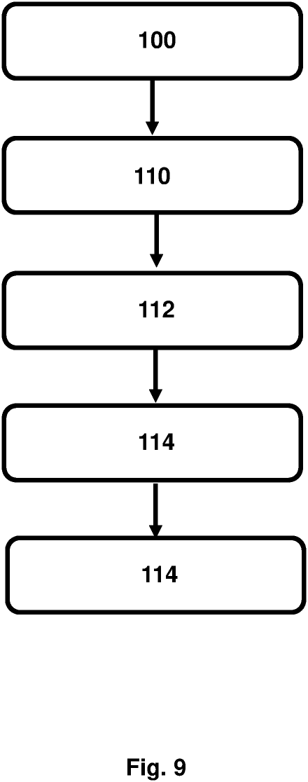

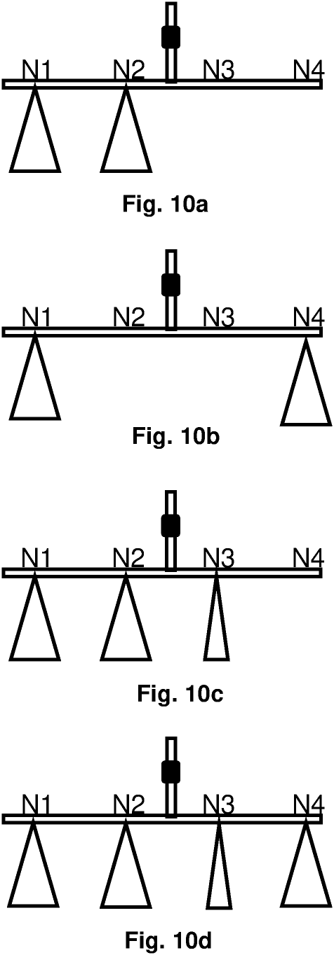

FIG. 9 illustrates an example of the method monitoring spray application of multiple spray nozzles 28. FIGS. 10 a, b, c and d illustrate nozzle configurations resulting from different activation signals during operation of the spray device. 10.

In step 100 an activation signal including nozzle identity and nozzle application mode for all nozzles may be obtained. The activation signal may for instance in spot spraying include data signifying the nozzle identity and for each nozzle identity the nozzle status on or off. For the situation illustrated in FIG. 10a at time a, the activation signal indicates: N1: on; N2: on, N3: off, N4: off. For the situation illustrated in FIG. 10b at time b, the activation signal indicates: N1: on; N2: off, N3: off, N4: on. For the situation illustrated in FIG. 10c at time c, the activation signal indicates: N1: on; N2: on, N3: on, N4: off. For the situation illustrated in FIG. 10d at time d, the activation signal indicates: N1: on; N2: on, N3: on, N4: on. The activation signal may further include data signifying the application rate for all nozzles or for each nozzle 28 individually. In the example N3 may be associated with an application rate lower than the nozzles N1, N2 or N4.

The activation signal including an operation status per nozzle may be obtained at set frequency e.g. ranging from seconds to milliseconds depending on the actuation frequency of the nozzles 28 and the speed of the spray device 10. Alternatively, the activation signal may be obtained in regular or irregular sampling frequencies lower than the actuation frequency of the nozzles 28. In other words, samples of the activation signal may be obtained at lower frequency than the actuation frequency of the nozzles. The activation signal may by obtained at a frequency dependent on the detection mechanism and the identification of a spray condition on the field.

In step 110, flow sensor signals measured by the flow sensor 34 and associated with the respective activation signal is obtained. The flow sensor signals may be obtained at different points in time corresponding to the actuation frequency of the nozzles 28. The points in time may include a time correction due to flow latencies or latencies in signal processing. The flow sensor 34 may provide one or more flow rate(s) associated with the respective activation signal. The flow sensor signal may be the flow rate. From the flow sensor signals a derived quantity such as a flow volume may be obtained.

In an optional step 112, the flow rate or volume per nozzle may be determined based on the obtained activation signal, in particular based on the number of activated nozzles. For instance, in the situation shown in FIG. 10a two nozzles N1 and N2 are activated, while in the situation shown in FIG. 10d four nozzles N1, N2, N3 and N4 are activated. From the flow sensor signals associated with the activation signal a per nozzle quantity such as the flow volume per nozzle 28 may be determined.

In step 114, the flow rate or volume may be compared with a set point. Such set point may be provided by the control unit generating the activation signal for the individual nozzles including e.g. respective application rates. The set point may relate to a total or a per nozzle quantity. For instance, the set point may include the flow volume per nozzle as derived from the actuation frequency and the activation signal provided by the activation signal. For instance, in the situation shown in FIG. 10a two nozzles N1 and N2 are activated and the set point may indicate a total volume of 200 ml in one actuation or activation cycle. In such case the set point may be 200 ml as total quantity or 100 ml as per nozzle quantity. In the situation shown in FIG. 10d four nozzles N1, N2, N3 and N4 are activated and the set point may indicate a total volume of 400 ml in one actuation cycle. In such case the set point may be 400 ml as total quantity or 100 ml as per nozzle quantity. From the flow sensor signals associated with the activation signal the total or per nozzle quantity such as the flow volume per nozzle 28 may be determined and compared to the respective setpoint.

In step 116, a warning is issued, if the comparison or the difference of the flow rate or volume and the setpoint exceeds a threshold. Such warning may be nozzle specific, if the specific nozzle can be identified based on historic data detected during the ongoing operation run of the spray device 10 as will be lined out in the example of FIG. 8.

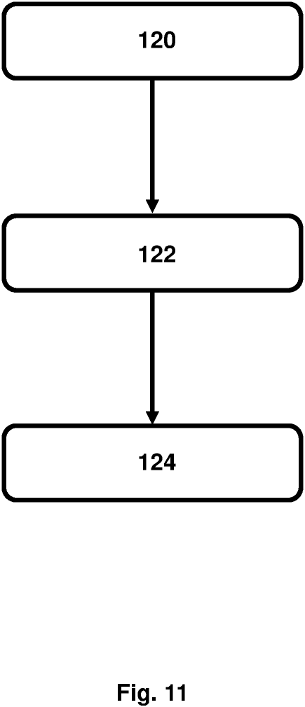

FIG. 11 illustrates an example of the method for monitoring spray application of multiple spray nozzles 28 based on historic data.

In step 120 flow sensor signals and associated activation signals are obtained for different points in time during the ongoing operation run. An operation run may be a herbicide treatment or a fungicide treatment of the agricultural field 11. During execution of the operation for the specific task the spray device 10 may log the flow sensor signals or derived quantities and associated activation signals.

In step 122 the flow sensor signals or derived quantities and their associated activation signals signifying different nozzle configurations are compared for different points in time during the operation run. For instance, in the situation shown in FIG. 10a two nozzles N1 and N2 are activated and both nozzles apply the set fluid amount to the field 11. In the situation shown in FIG. 10c three nozzles N1, N2 and N3 are activated and nozzle N3 applies less fluid than nozzles N1 and N2. In such case the flow sensor signals, or derived quantities allow to detect the deviation in fluid applied through the nozzles N1, N2 and N3. In combination with the nozzle configuration shown in FIG. 10a activated at a time a prior to time c such defect of nozzle N3 can be detected based on the sensor flow signals provided by the fluid flow sensor 34 in the common fluidic line 26. Through such combinatoric approach, the nozzle defect can be detected in a highly effective manner based on the sensor flow signals provided by the single fluid flow sensor 34 in the common fluidic line 26.

In step 124, the nozzle indicating the defect is identified. A defect may be for instance a nozzle blocking or electrical or mechanical breakages. Such warning may be provided to a control system of the spray device 10. It may be provided to the operator of the spray device 10 e.g. via a terminal of the spray device or any other suitable client device such as a mobile phone. In reaction to such warning the operator may pause the operation and for instance unblock a filter that lead to the blockage in nozzle N3.

Similar to the described monitoring of individual nozzles through the flow sensor in the common fluidic line 26 by use of the activation signal, the tank valves shown e.g. in the illustrative setup of FIG. 5 may be monitored. In such setup the tank valves and with that the composition released by the nozzles 28 to the field 11 may be monitored via the composition sensor 34.6 in the common fluidic line 26 or the common fluidic line segment 26 by use of the activation signal. As a result, not only the rate at which the nozzles 28 release fluid, but also the composition released by the nozzles 28 may be monitored. This allows for a simple and cost-effective approach to monitoring two detrimental factors determining the efficacy of the treatment task on the field. Monitoring of the application rate and composition are amongst others key factors for ensuring the treatment task is conducted as planned on the machinery side.

The smart aggregation of information relating to the activation signal (which nozzle is active when) and the flow in the common fluidic line 26 of the spray device 20 allows for a simple monitoring of individual spray nozzles 28 without the need for multiple sensors per nozzle. In particular historical data from the operation run may be used to identify defective nozzles. In this case the spray nozzle specific fluid property is derived from the measurement via the sensor 34 in the common fluidic line 26 and historical data recorded during the operation run. Historical data may include data generated by the farming machinery 10 or spray device 20 during operation while executing a task on the agricultural area 11. It may include activation signals and associated fluid property measurements.

The method is particularly useful in the smart machinery arena using spot spraying, since here small amounts of fluid are released per nozzle per spot application. It may be as low as multiple 10 or 100 ml/s with overall amount to be applied on the full agricultural area in the area of a couple of 100 I/ha.

The example embodiments of the invention cover both, a computer program that right from the beginning uses the invention and a computer program that by means of an up-date turns an existing program into a program that uses the invention. Further on, the computer program element might be able to provide all necessary steps to fulfil the procedure of an embodiment of the method as described above.

According to a further example embodiment of the present invention, a computer readable medium, such as an ASIC, a storage chip, a RAM or the like, is presented wherein the computer readable medium has a computer program element stored on it which computer program element is described by the preceding section.

A computer program may be stored and/or distributed on a suitable medium, such as an optical storage medium or a solid-state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further example embodiment of the present invention, a medium for making a computer program element available for downloading is provided, which computer program element is arranged to perform a method according to one of the previously described embodiments of the invention.

It has to be noted that embodiments of the invention are described with reference to different subject matter. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are recited in mutually different dependent claims does not indicate that a combination of these measures cannot be used to advantage. Any reference signs in the claims should not be construed as limiting the scope.

1. A spray device (20) with more than one spray nozzle (28) to treat an agricultural area (11), wherein at least two spray nozzles (28) are fluidly connected via a common fluidic line (26), the spray device (20) comprising:
a control system (32) configured to control activation of individual spray nozzle(s) based on an activation signal derived from detecting conditions to be sprayed on the agricultural area (11);
a sensor (34) configured to measure a fluid property in the common fluidic line (26); and
a monitoring unit configured to monitor individual spray nozzles (28) based on the measured fluid property and the activation signal.

2. The spray device (20) of claim 1, wherein the monitoring unit is configured to provide and/or determine a fluid amount applied through a fluid flow measurement and/or a fluid composition applied as determined through a fluid composition measurement.

3. The spray device (20) of claim 1,wherein the spray device includes a sensor (34) configured to measure a fluid flow and/or a sensor configured to measure a fluid composition in the common fluidic line (26), wherein the monitoring unit is configured to correct the fluid amount applied based on a measured back flow or cyclic flow of fluid to one or more tank(s) (23, 24, 25) after an application.

4. The spray device (20) of claim 1, wherein the monitoring unit is configured to determine an expected fluid property based on the activation signal and/or historical data from previous operation runs of the spray device.

5. The spray device (20) of claim 1, wherein the monitoring unit (36) is configured to determine a spray nozzle (28) specific fluid property from measurement via the sensor (34) associated with the common fluidic line (26) and/or historical data recorded during the operation run.

6. The spray device (20) of claim 1, wherein the monitoring unit (36) is configured to determine a problematic spray nozzle based on historical data recorded during the operation run and the fluid flow measurement in the common line (26), wherein the monitoring unit is configured to provide a position of the problematic spray nozzle to the control system and/or an operator of the spray device.

7. The spray device (20) of claim 1, wherein the monitoring unit (36) is configured to provide a warning signal, if the measured fluid property diverges from the expected fluid property.

8. The spray device (20) of claim 1, further comprising or being communicatively coupled to a positioning system (32, 36) configured to provide a position information to the monitoring unit or the control system corresponding to the time of the measurement of the fluid property, wherein the monitoring unit or the control system is configured to record the measured fluid property and the position information during spray operation.

9. A method for monitoring spray application of a spray device (20) with more than one spray nozzle (28) to treat an agricultural area (11), wherein at least two spray nozzles (28) are fluidly connected via a common fluidic line (26), the method comprising the
providing an activation signal for individual spray nozzle(s) (28) to control activation of individual spray nozzle(s) based on an activation signal derived from detecting conditions to be sprayed on the agricultural area (11);
providing a fluid property measurement from a sensor (34) configured to measure a fluid flow in the common fluidic line (26); and
monitoring individual spray nozzles (28) based on the measured fluid flow and the activation signal.

10. The method of claim 9, further comprising
providing a field condition and generating an activation signal for individual spray nozzle(s) (28).

11. The method of claim 9, wherein monitoring includes:
determining an expected fluid property based on the activation signal and/or historical data from previous operation runs of the spray device (20); and
providing a warning signal, if the expected fluid property diverges from the measured fluid property.

12. The method of claim 9, further comprising
providing a position information corresponding to the time of the measurement of the fluid property; and
recording the measured fluid property and the position information during spray operation.

13. The method of claim 9, further comprising
determining a spray nozzle (28) specific fluid property from measurement via the sensor in the common fluidic line (26) and/or historical data recorded during the operation run.

14. A computer program or computer program product or a machine-readable storage device with executable instructions or a control device with executable instructions, which when executed on a computing device, performs the method of claim 9.

15. A control device (32) with executable instructions, which when executed on a computing device, perform the method of claim 9.

16. A fanning machinery including the spray device (20) of claim 1.
